(19) United States
(12) Patent Application Publication
(10) Pub. No.: US 2023/0047826 A1
(43) Pub. Date: Feb. 16, 2023

(54) CONTEXT BASED PERFORMANCE BENCHMARKING

(71) Applicant: KONINKLIJKE PHILIPS N.V., EINDHOVEN (NL)

(72) Inventors: Qianxi LI, CAMBRIDGE, MA (US); Lucas De Melo OLIVEIRA, WILMINGTON, MA (US); Jochen KRUECKER, ANDOVER, MA (US)

(21) Appl. No.: 17/782,716

(22) PCT Filed: Dec. 15, 2020
(86) PCT No.: PCT/EP2020/086089

§ 371 Date: Jun. 6, 2022

Related U.S. Application Data
(60) Provisional application No. 62/951,492, filed on Dec. 20, 2019.

(51) Int. Cl. G06Q 10/06

(52) U.S. Cl. CPC G06Q 10/06393

(57) ABSTRACT

A system (102) includes a digital information repository (106) configured to store information about performances of individuals, including performances of an individual of interest. The system further includes a computing apparatus (103). The computing apparatus includes a memory (110) configured to store instructions for a performance benchmarking engine trained to learn factors of the performances that impact key performance indicators independent of the individuals’ performance. The computing apparatus further includes a processor (108) configured execute the stored instructions for the performance benchmarking engine to determine a key performance indicator of interest for the individual of interest based at least in part on the information in the digital information repository about the performances of the individual of interest and the learned factors that impact the key performance indicator of interest.

### FIELD OF THE INVENTION

The following generally relates to performance benchmarking and more particularly to context-based performance benchmarking.

### BACKGROUND OF THE INVENTION

A key performance indicator (KPI) can been used to evaluate a performance of individuals. For instance, a manager of a clinical department of a healthcare facility can utilize a KPI to evaluate a performance of a staff member of the clinical department. For example, a manager of an echocardiogram laboratory can use a KPI to evaluate a performance of individual sonographers with respect to performing echocardiograms. An example KPI in this instance is an average time duration to perform an echocardiogram.

However, a complexity of performing an echocardiogram varies not only based on a sonographer’s performance but also on factors outside of the control of the sonographer such as a patient-specific clinical context (e.g., inpatient versus output, etc.) and/or a workflow context (e.g., equipment model, etc.). As a consequence, performance benchmarking of individual sonographers for performing echocardiograms is affected by the patient-specific clinical context and/or the workflow context, regardless of the performance of the sonographers.

As such, all else being equal, the same KPI for two different sonographers can be different based on the patient-specific clinical context and/or the workflow context. Thus, current approaches to performance benchmarking can lead to a biased evaluation with a less accurate interpretation of the individual’s performance, e.g., depending on the context. Hence there is an unresolved need for another and/or improved approach(s) for performance benchmarking.

### SUMMARY OF THE INVENTION

Aspects described herein address the above-referenced problems and/or others. For instance, a non-limiting example embodiment described in greater detail below considers patient-specific clinical context and/or workflow context to determine a more accurate and meaningful KPI without such biases based performance benchmarking.

In one aspect, a system includes a digital information repository configured to store information about performances of individuals, including performances of an individual of interest. The system further includes a computing apparatus. The computing apparatus includes a memory configured to store instructions for a performance benchmarking engine trained to learn factors of the performances that impact key performance indicators independent of the individuals’ performance. The computing apparatus further includes a processor configured execute the stored instructions for the performance benchmarking engine to determine a key performance indicator of interest (1010) for the individual of interest based at least in part on the information in the digital information repository about the performances of the individual of interest and the learned factors that impact the key performance indicator of interest.

In another aspect, a method includes obtaining information about performances of individuals, including performances of an individual of interest, from a digital information repository. The method further includes obtaining instructions for a performance benchmarking engine trained to learn factors of the performances that impact key performance indicators independent of the individuals’ performance. The method further includes executing the instructions to determine a key performance indicator of interest for the individual of interest based at least in part on the information in the digital information repository about the performances of the individual of interest and the learned factors that impact the key performance indicator of interest.

In another aspect, a computer-readable storage medium stores instructions that when executed by a processor of a computer cause the processor to: obtain information about performances of individuals, including performances of an individual of interest, from a digital information repository, obtain instructions for a performance benchmarking engine trained to learn factors of the performances that impact key performance indicators independent of the individuals’ performance, and execute the instructions to determine a key performance indicator of interest for the individual of interest based at least in part on the information in the digital information repository about the performances of the individual of interest and the learned factors that impact the key performance indicator of interest.

Those skilled in the art will recognize still other aspects of the present application upon reading and understanding the attached description.

### BRIEF DESCRIPTION OF THE DRAWINGS

The invention may take form in various components and arrangements of components, and in various steps and arrangements of steps. The drawings are only for purposes of illustrating the embodiments and are not to be construed as limiting the invention.

FIG. 1 diagrammatically illustrates an example system with a performance benchmarking engine configured for context-based KPI performance benchmarking, in accordance with an embodiment(s) herein.

FIG. 2 diagrammatically illustrates an example of the performance benchmarking engine including a patient-specific clinical and/or workflow profiling module, a patient-specific clinical and/or workflow factor identifying module, and a benchmark performance module, in accordance with an embodiment(s) herein.

FIG. 3 diagrammatically illustrates an example of the patient-specific clinical and/or workflow profiling module, in accordance with an embodiment(s) herein.

FIG. 4 diagrammatically illustrates an example of the patient-specific clinical and/or workflow factor identifying module, in accordance with an embodiment(s) herein.

FIG. 5 graphically illustrates example factor identification using a decision tree algorithm, in accordance with an embodiment(s) herein.

FIG. 6 graphically illustrates example factor identification using a random forest algorithm, in accordance with an embodiment(s) herein.

FIG. 7 graphically illustrates patient type affects echocardiogram time duration, in accordance with an embodiment(s) herein.

FIG. 8 graphically illustrates equipment model affects echocardiogram time duration, in accordance with an embodiment(s) herein.

FIG. 9 graphically illustrates contrast use affects echocardiogram time duration, in accordance with an embodiment(s) herein.

FIG. 10 diagrammatically illustrates an example of the benchmark performance module, in accordance with an embodiment(s) herein.

FIG. 11 graphically illustrates an example KPI determined considering patient-specific clinical context and/or workflow context, in accordance with an embodiment(s) herein.

FIG. 12 graphically illustrates an example KPI determined without considering patient-specific clinical context and/or workflow context, in accordance with an embodiment(s) herein.

FIG. 13 illustrates an example method, in accordance with an embodiment(s) herein.

### DETAILED DESCRIPTION OF EMBODIMENTS

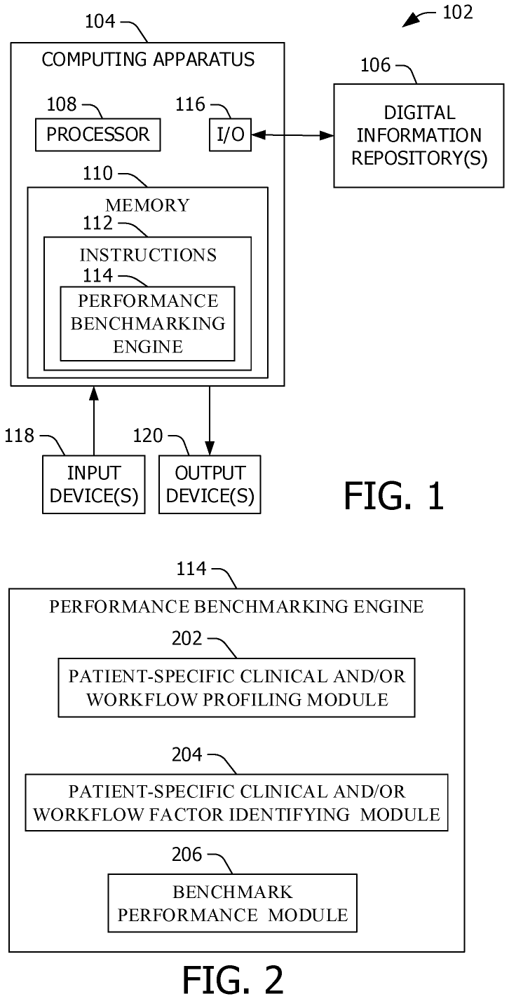

FIG. 1 diagrammatically illustrates an example system 102 configured for context-based KPI performance benchmarking. “Context-based” as utilized herein includes considering factors that affect an overall performance of an individual under evaluation but are independent of the individual’s performance. By way of example, an older computer with a slower processor will generally take longer to perform a computation relative to a newer computer with a faster processor, regardless of the operator’s use of the computer. The system 102 includes a computing apparatus 104 (e.g., a computer) and a digital information repository(s) 106.

The illustrated computing apparatus 104 includes a processor 108 (e.g., a central processing unit (CPU), a microprocessor (µCPU), and/or other processor) and computer readable storage medium (“memory”) 110 (which excludes transitory medium) such as a physical storage device like a hard disk drive, a solid-state drive, an optical disk, and/or the like. The memory 110 includes instructions 112, including instructions for a performance benchmarking engine 114. The processor 108 is configured to execute the instructions for performance benchmarking.

The illustrated computing apparatus 104 further includes input/output (“I/O”) 116. In the illustrated embodiment, the I/O 116 is configured for communication between the computing apparatus 104 and the digital information repository(s) 106, including receiving data from and/or transmitting a signal to the digital information repository(s) 106. The digital information repository(s) 106 includes a physical storage device(s) that stores digital information. This includes local, remote, distributed, and/or other physical storage device(s).

A human readable output device(s) 120, such as a display, is in electrical communication with the computing apparatus 104. In one instance, the human readable output device(s) 120 is a separate device configured to communicate with the computing apparatus 104 through a wireless and/or a wire-based interface. In another instance, the human readable output device(s) 120 is part of the computing apparatus 104. An input device(s) 119, such as a keyboard, mouse, a touchscreen, etc., is also in electrical communication with the computing apparatus 104.

The performance benchmarking engine 114 includes trained artificial intelligence. As described in greater detail below, the performance benchmarking engine 114 is trained at least with data from the digital information repository(s) 106 to learn context that affects overall performance independent of an individual’s performance and then determines a KPI(s) for the individual with data from the digital information repository(s) 106 and factors from the context. In one instance, this provides a more meaningful KPI based performance benchmarking relative to an embodiment in which context is not considered, which leads to a biased evaluation with a less accurate interpretation of the individual’s performance.

The computing apparatus 104 can be used for performance benchmarking in various environments. In one instance, the computing apparatus 104 is used for performance benchmarking in the clinical environment. In this environment, the performance benchmarking engine 114 considers patient-specific clinical context and/or workflow context. “Patient-specific clinical context” includes factors such as patient body mass index, age, type, diagnosis, length of hospital stay, and/or other factors. “Workflow context” includes factors such as equipment model, location of examination, operator, study type, clinician, and/or other factors.

The below is described with particular application to the clinical environment but is not limited thereto. FIG. 2 diagrammatically illustrates an example of the performance benchmarking engine 114. In this example, the performance benchmarking engine 114 includes a patient-specific clinical and/or workflow profiling module 202, a patient-specific clinical and/or workflow factor identifying module 204 and a benchmark performance module 206. The following describes non-limiting examples of the patient-specific clinical and/or workflow profiling module 202, the patient-specific clinical and/or workflow factor identifying module 204 and the benchmark performance module 206.

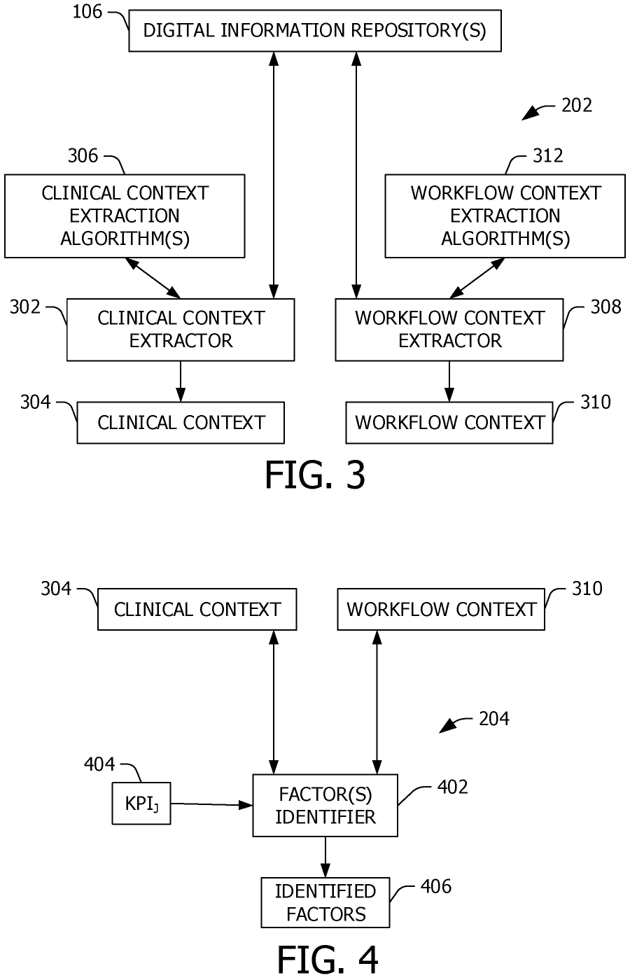

FIG. 3 diagrammatically illustrates an example of the patient-specific clinical and/or workflow profiling module 202 of the performance benchmarking engine 114 in connection with the digital information repository(s) 106. In this example, the digital information repository(s) 106 includes a hospital information system (HIS), including one or more of an electronic medical record (EMR), radiology information system (RIS), cardiovascular information systems (CVIS), a laboratory information system (LIS), a picture archiving and communication system (PACS), and/or other information system, an imaging system(s), and/or other system. The computing apparatus 104 can interface with such systems via information technology (IT) communication protocol such as Health Level Seven (HL7), Digital Imaging and Communications in Medicine (DICOM), Fast Healthcare Interoperability Resources (FHIR), etc.

One or more of the above systems stores data in a structured format. An example structured report includes one or more of the following: 1) a header section with patient demographic information (e.g., patient name, patient age, patient height, blood pressure, etc.) and order information (e.g., ordering physician, study type, reason for study, medical history, etc.); 2) a section for documenting related personnel (e.g., ordering physician, technologists, diagnosing physician, etc.); 3) a section for documenting measurements and clinical findings; 4) a section for a conclusion to summarize and highlight certain findings, and/or 5) a section for billing. In one instance, the digital information repository(s) 106 stores information in a structured free-text report format. Additionally, or alternatively, the digital information repository(s) 106 stores each field in a structured database.

A clinical context extractor 302 extracts a clinical context 304 from the digital information repository(s) 106 using a clinical context extraction algorithm(s) 306. A workflow context extractor 308 extracts workflow context 310 from the digital information repository(s) 106 using a workflow context extraction algorithm(s) 312. For the structured free-text report format, the clinical context extraction algorithm(s) 306 and the workflow context extraction algorithm(s) 312 include algorithms such as a natural language processing (NLP) algorithm or the like to recognize subheading of each item of information. For the structured database, the clinical context extraction algorithm(s) 306 and the workflow context extraction algorithm(s) 312 retrieve information through, e.g., a database query.

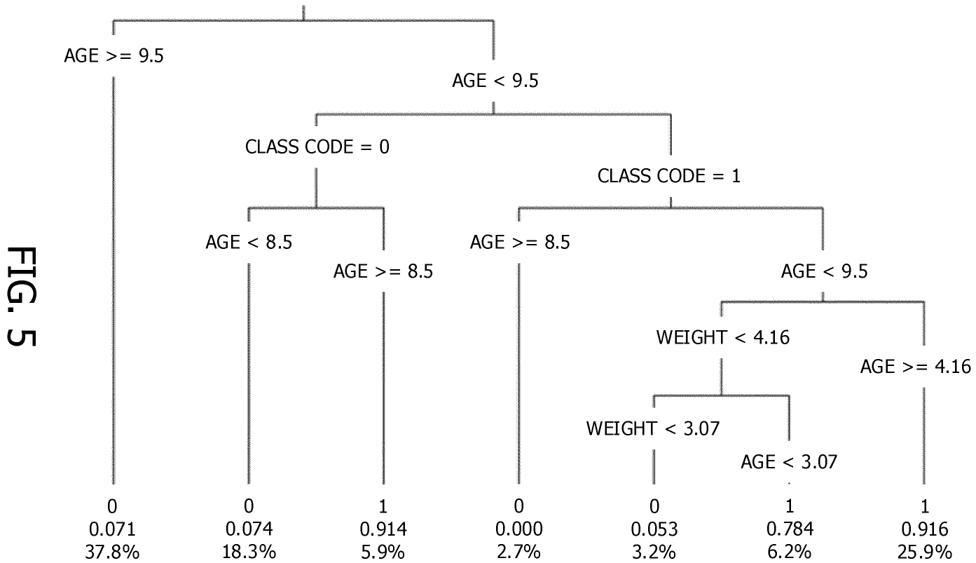

FIG. 4 diagrammatically illustrates an example of the patient-specific clinical and/or workflow factor identifying module 204 of the performance benchmarking engine 114. A factor(s) identifier 402 receives, as input, the clinical context 304 and/or the workflow context 310. For each KPI of interest 404 (e.g., a KPI_{J}), the factor(s) identifier 402 identifies clinical and workflow factors 406 that affect performance independent of the individual under evaluation. Several examples below describe how the factor(s) identifier 402 evaluates the clinical context 304 and/or the workflow context 310 to identify factors of interest for performance benchmarking a sonographer. Example approaches include supervised prediction and/or classification such as statistical modelling, machine learning, rule-based, deep learning, etc., manual approaches, etc.

In one example, the factor(s) identifier 402 employs a decision tree to identify the factors that affect examination duration. The input to the decision tree includes the clinical context 304 and/or the workflow context 310. Examples of factors that would affect exam duration such as patient age, patient weight, diastolic pressure, patient height patient class, gender, reason for study, type of ultrasound cart, patient location etc.

In one instance, the decision tree is trained as a classification problem to learn what factors determine whether the examination duration would last over or under a threshold time (e.g., 30 minutes). For this, the clinical context 304 and/or the workflow context 310 is divided into multiple classes. In each class, the expected examination duration would be a similar range regardless of the capabilities of sonographers. For example, the data can be classified into two groups, a first group that takes less than thirty minutes and a second group that takes more than thirty minutes.

The output of the decision includes the classification result as well as clinical and/or workflow factors and splitting conditions used to make the classification. An example of such results is shown in FIG. 5. The classification results (0,1) are displayed as end nodes of a decision tree and the factors and splitting conditions are displayed as nodes on the decision tree (e.g. age > 9.5). The data is classified into two classes, class codes 0 and 1. The input to the decision tree includes patient age, patient class (0 = outpatient; 1 = inpatient) and patient weight.

The output of the decision tree includes selected factors that would contribute to the classification and the division threshold for each of the selected factors. In FIG. 5, the data of patients with age older than 9.5 tends to last under 30 minutes. The data could be grouped into class 0 (under 30 minutes) and 1 (over 30 minutes) according to the output of the decision tree. Based on the dataset from each class, the productivity performance of sonographers can be compared. The example could be generalized to include more input factors and to make classification for multi-classes.

An unbiased / less biased or more fair benchmarking can then be performed based on the results of the decision tree. For instance, the decision tree of FIG. 5 indicated that patient age is a factor that affects examination time duration regardless of a sonographer’s performance, where the examination time duration for patients older than 9.5 years old tends to be under 30 minutes. In this instance, sonographer productivity benchmarking is performed, e.g., by comparing at least the examination time durations of the sonographers for examinations of patients older than 9.5 years old since the examination time duration for these examination is expected to be less than 30 minutes and an examination time duration greater than 30 minutes is likely due to the sonographer’s performance.

Such benchmarking is achieved through knowing only the classification results, without understanding how classification is performed by the algorithm. In other words, understanding a list of potential factors that would affect exam duration is not needed for performance benchmarking. However, providing such information would increase interpretability.

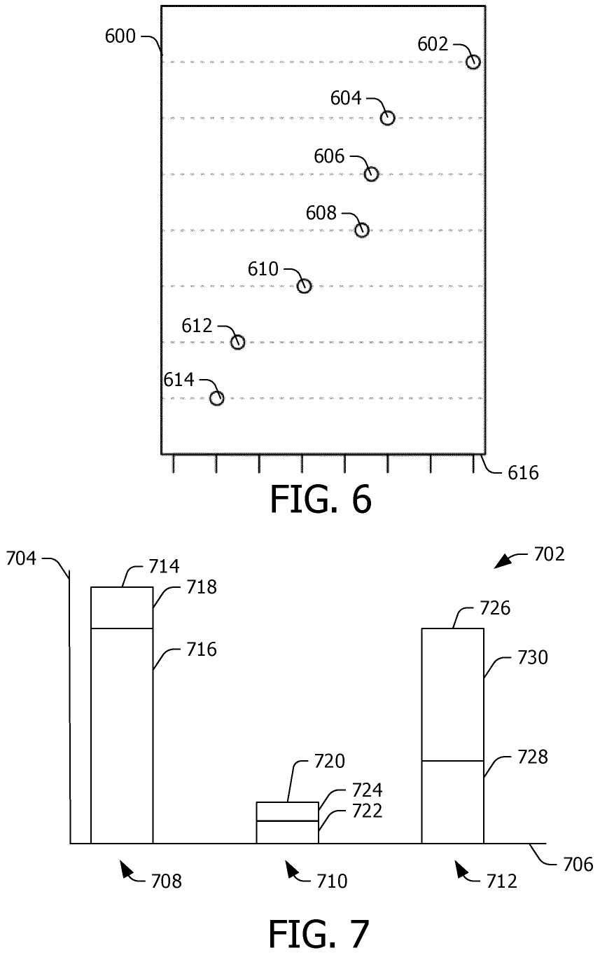

Other algorithms could also be applied. For example, random forest could also be applied, with the same inputs. The algorithm would predict the classification of each case and identify the important factors. An example of this is shown in FIG. 6, which includes a first axis 600 that identifies clinical and/or workflow factors (an age 602, a diastolic pressure 604, a height 606, a weight 608, a class code 610, a sonographer 612, a gender 614, etc.) which affect examination duration. Random forest combines the result of a number of decision trees and thus the basic principle of random forest is similar to decision trees.

For each split on the tree, the algorithm identifies the factor (i.e. age) and the condition of the factor (i.e. age > 9.5) to split the dataset in order to achieve the best classification result. The criteria used in random forest to select the factor and the condition is based on impurity. A second axis 616 in FIG. 6 is a Gini impurity index that measures an impurity level of the dataset. If all the data in a dataset belongs to one group, then the impurity level (or Gini impurity index) is at a lowest level. Random forest outputs the main factors that contribute to the decreasing of the Gini impurity. These factors contribute to a good classification performance.

In another example, a statistical method could also be applied. For example, the correlation between potential factor and examination duration can be utilized. With machine learning algorithms, the performance of the predictor is highly dependent on the input features. As such, an optional module allows a healthcare professional (cardiologists, fellow, manager of echocardiogram laboratories, etc.) to configure which indicators/features from the patient/study profiling would be relevant for prediction. This enables a scalable way to incorporate clinical insights to guide algorithm design.

FIGS. 7, 8 and 9 graphically illustrate examples of factors that affect echocardiogram time duration independent of the sonographer’s performance, in accordance with an embodiment(s) herein.

FIG. 7 graphically illustrates that patient type affects echocardiogram time duration, in accordance with an embodiment(s) herein. A bar chart 702 includes a first axis 704 that represents a number of echocardiograms performed and a second axis 706 represents a time duration for each echocardiogram. In this example, there are three time duration ranges, a first time duration range 708 (e.g., t < 30 minutes), a second time duration range 710 (e.g., 30 minutes ≤ t ≤ 60 minutes) and a third time duration range 712 (e.g., t > 30 minutes).

A first bar 714 at the first time duration range 708 includes a first portion 716 that represents a number of outpatients and a second portion 718 that represents a number of inpatients. A second bar 720 at the second time duration range 710 includes a first portion 722 that represents a number of outpatients and a second portion 724 that represents a number of inpatients. A third bar 726 at the third time duration range 712 includes a first portion 728 that represents a number of outpatients and a second portion 730 that represents a number of inpatients.

From the delineation between inpatients and outpatients, FIG. 7 shows that on average most inpatient echocardiograms fall in the third time duration 712. However, with a KPI based on the time duration without considering patient type, sonographers in the third time duration 712 appear to be underperforming. As a consequence, benchmarking performance without taking into consideration factors outside of the control of the individual being evaluated leads to a biased evaluation with a less accurate interpretation of performance in this example.

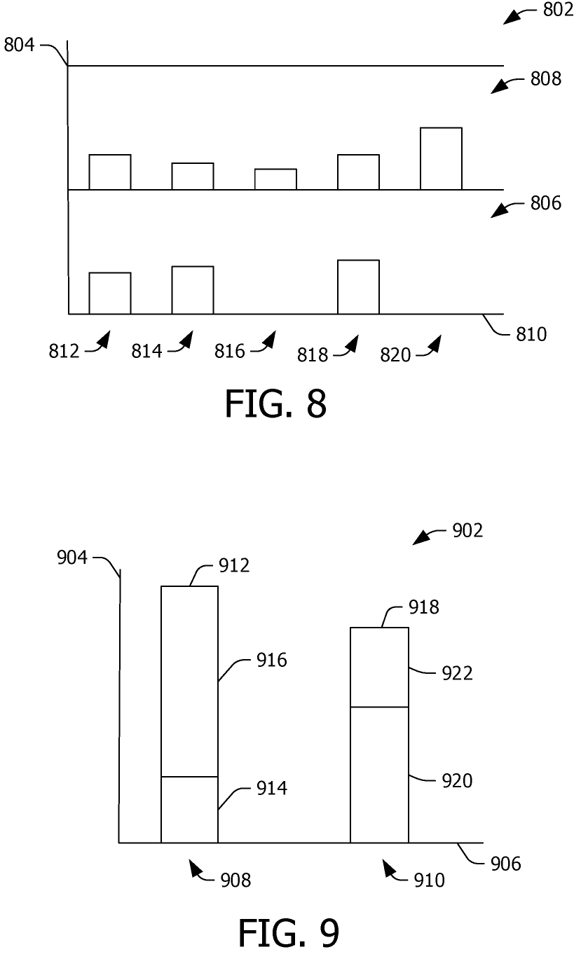

FIG. 8 graphically illustrates that equipment model affects echocardiogram time duration, in accordance with an embodiment(s) herein. A bar chart 802 includes a first axis 804 that represents type of examinations, including a first type of echocardiogram 806 (e.g., transesophageal echocardiograms (TEE)) and a second type of echocardiogram 808 (e.g., fetal). A second axis 810 represents ultrasound model, including a model 812, a model 814, a model 816, a model 818 and a model 820. In this example, the equipment model 820 is older than the other equipment models and, on average, requires ten minutes longer to complete an echocardiogram relative to the other equipment models.

From the delineation between equipment models, FIG. 8 shows that on average echocardiograms performed with the older equipment model 820 took longer to complete (i.e. had a longer time duration) than echocardiograms performed with the other equipment models. However, with a KPI based on the time duration without considering equipment model, sonographers using the older equipment model D 820 appear to be underperforming. As a consequence, benchmarking performance without taking into consideration factors outside of the control of the individual being evaluated leads to a biased evaluation with a less accurate interpretation of performance in this example.

FIG. 9 graphically illustrates that contrast affects echocardiogram time duration, in accordance with an embodiment(s) herein. A bar chart 902 includes a first axis 904 represents contrast utilization and a second axis 906 represents ultrasound model, including a model 908 and a model 910. A first bar 912 for the model 908 includes a first portion 914 that indicate contrast-enhanced scans and a second portion 916 that indicates contrast free scans. A second bar 918 for the model 910 includes a first portion 920 indicate contrast-enhanced scans and second portion 922 that indicates contrast free scans.

From the delineation between contrast enhanced and non-contrast scans, FIG. 9 shows that on average more contrast is required to complete a scan when using the model 910 to perform the scan than the amount of contrast to complete a scan when using one of the other models. However, with a KPI based on the contrast without considering equipment model, sonographers using the model 910 appear to be underperforming. As a consequence, benchmarking performance without taking into consideration factors outside of the control of the individual being evaluated leads to a biased evaluation with a less accurate interpretation of performance in this example.

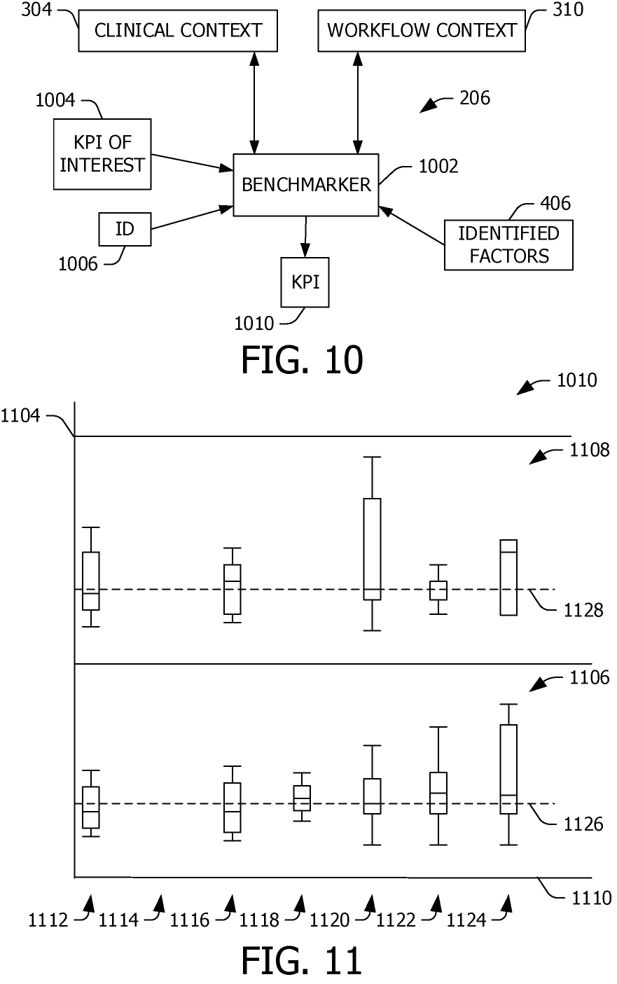

FIG. 10 diagrammatically illustrates an example of the benchmark performance module. A benchmaker 1002 receives a KPI of interest 1004 and an identification of an individual of interest (ID) 1006, e.g., via the input device(s) 118. The benchmaker 1002 also retrieves the clinical context 304 and/or the workflow context 310 and the identified factors 406. The benchmaker 1002 determines a KPI 1010 for the individual based on the KPI of interest 1004, the clinical context 304 and/or the workflow context 310 and the identified factors 406.

FIG. 11 show an example of the KPI 1010 of FIG. 10 where the KPI of interest 1004 is for sonographer productivity via examination duration, taking into patient type (inpatient or outpatient). A first axis 1104 represents image acquisition duration for two types of patient, inpatient 1106 and outpatient 1108. A second axis 1110 represents sonographers, including sonographers 1112, 1114, 1116, 1118, 1120, 1122, and 1124. For the sonographer 1120, an average time duration 1126 for inpatient examinations 1106 and an average time duration 1128 for outpatient examinations 1108 both fall around the average of all the sonographers, and the sonographer 1120 mainly performs inpatient examinations, which, on average, take more time to complete than outpatient examinations.

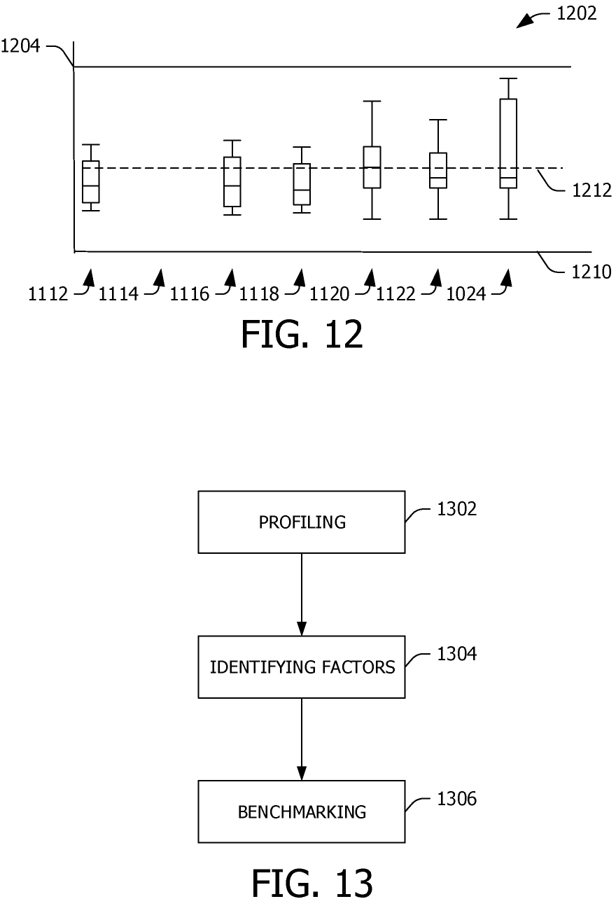

For comparison, FIG. 12 shows an example where a KPI determined from the same data used for the KPI 1010 of FIG. 10 but not considering the patient type (inpatient or outpatient). A first axis 1204 represents image acquisition duration for two types of patient, inpatient 1206 and outpatient 1208. A second axis 1210 represents sonographer, including the sonographers 1112, 1114, 1116, 1118, 1120, 1122, and 1124. For the sonographer 1120, an average time duration 1212 is above the average of all the sonographers. Hence, without considering patient type, the KPI indicates that the sonographer 1120 takes longer (i.e., more time) than the other sonographers to complete an examination, unlike the KPI 1010 show in FIG. 11. That is, the KPI in FIG. 11 is biased against the sonographer 1120, relative to the KPI 1102 of FIG. 10, by not taking patient type into account.

In general, the factors can be used to provide a clinical context to the situation. To do this, the data can be filtered according to the selected clinical and workflow factors and identified condition. Then a fair benchmarking could be achieved based on each subset of the filtered cohort. Additionally, or alternatively, data can be grouped based on the classification result, and comparisons can be performed accordingly. In another embodiment, the list of clinical and/or workflow factors can be grouped to derive a single comprehensive factor used in performance benchmarking, which may increase interpretability.

One example would be to use multiple factors to determine a comprehensive factor measuring the amount of care required by this specific case. For example, case complexity could be a comprehensive factor, which is used to measure how ‘difficulty’ the case is to be performed. For example, it is harder to scan an obese stroke patient than to scan a patient with normal BMI to evaluate left ventricular function. Here, the system can use multiple factors including BMI (indicating obese), patient history (indicating stroke) and reason for study (to evaluate left ventricular function) to derive a comprehensive factor - case complexity. Benchmarking performance can then be based on complexity level. Evaluating the productivity per sonographer by comparing average exam duration for studies at the same complex level is fair and meaningful.

For explanatory purposes, the above included non-limiting examples for benchmarking sonographer performance, taking into account factors that are independent of the sonographer. However, it is to be understood that the approach herein can also be used for performance benchmarking of other KPIs. For example, the approach described herein can be used for comparing improvements in workflow efficiency when using different ultrasound models, e.g., to identify factors that would affect the workflow efficiency which are independent of a performance of an ultrasound scanner, i.e. patient complexity, sonographers experience, etc.

FIG. 13 illustrates an example method in accordance with an embodiment(s) herein.

It is to be appreciated that the ordering of the acts in the method is not limiting. As such, other orderings are contemplated herein. In addition, one or more acts may be omitted, and/or one or more additional acts may be included.

A profiling step 1302 extracts relevant context from a digital data repository(s), as described herein and/or otherwise. For example, with particular application to the clinical environment, this may include extracting patient-specific clinical and/or workflow that extracts information from the digital information repository(s) 106.

An identifying factors step 1304 identifies factors from the extracted context that affect performance independent of the individual being evaluated, as described herein and/or otherwise. For example, for each KPI of interest, clinical and workflow factors 406 that affect performance independent of the individual under evaluation can be identified in the extracted relevant context.

A benchmarking step 1306 determines a KPI(s) for the individual based at least on the identified factors, as described herein and/or otherwise.

The above may be implemented by way of computer readable instructions, encoded or embedded on computer readable storage medium, which, when executed by a computer processor(s), cause the processor(s) to carry out the described acts. Additionally, or alternatively, at least one of the computer readable instructions is carried out by a signal, carrier wave or other transitory medium, which is not computer readable storage medium.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

The word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A system, comprising:
a digital information repository configured to store information about performances of individuals, including performances of an individual of interest; and
a computing apparatus, comprising:
a memory configured to store instructions for a performance benchmarking engine trained to learn factors of the performances that impact key performance indicators independent of the performances of the individuals; and
a processor configured to execute the stored instructions for the performance benchmarking engine to determine a key performance indicator of interest for the individual of interest based at least in part on the information in the digital information repository about the performances of the individual of interest and the learned factors that impact the key performance indicator of interest.

2. The system of claim 1, wherein the information includes a patient-specific clinical or workflow context.

3. The system of claim 2, wherein the performance benchmarking engine includes a patient-specific clinical and/or workflow profiling module configured to extract a clinical context from the digital information repository based on a clinical context extraction algorithm and a workflow context from the digital data repository based on a clinical context extraction algorithm.

4. The system of claim 3, wherein the information is stored in the digital information repository in a structured format, and the patient-specific clinical and/or workflow profiling module is configured to extract the clinical context and the workflow context using a natural language processing algorithm or a database query.

5. The system of claim 3, wherein the performance benchmarking engine includes a patient-specific clinical and/or workflow factor identifying module configured to determine the factors from the clinical context and the workflow.

6. The system of claim 5, wherein the patient-specific clinical and/or workflow factor identifying module is configured to determine the factors based on at least one of a supervised prediction or a classification.

7. The system of claim 5, wherein the performance benchmarking engine further includes a benchmark performance module configured to determine the key performance indicator of interest for the individual of interest to remove a performance bias introduced by the factors.

8. The system of claim 7, wherein the performance benchmarking engine further includes a benchmark performance module configured to determine the key performance indicator of interest for the individual of interest by excluding factors the introduce the performance bias.

9. The system of claim 1, further comprising:
an output device configured to display the determined key performance indicator of interest.

10. A computer-implemented method, comprising:
obtaining information about performances of individuals, including performances of an individual of interest, from a digital information repository;
obtaining instructions for a performance benchmarking engine trained to learn factors of the performances that impact key performance indicators independent of the individuals' performance; and
executing the instructions to determine a key performance indicator of interest for the individual of interest based at least in part on the information in the digital information repository about the performances of the individual of interest and the learned factors that impact the key performance indicator of interest.

11. The computer-implemented method of claim 10, further comprising:
extracting a clinical context from the digital data repository based on a clinical context extraction algorithm and a workflow context from the digital data repository based on a clinical context extraction algorithm.

12. The computer-implemented method of claim 11, wherein the information is stored in the digital information repository in a structured format, further comprising: extracting the clinical context and the workflow context using a natural language processing algorithm or a database query.

13. The computer-implemented method of claim 11, further comprising:
determining the factors from the clinical context and the workflow.

14. The computer-implemented method of claim 13, further comprising:
determining the factors using one of a supervised prediction or a classification.

15. The computer-implemented method of claim 13, further comprising:
determining the key performance indicator of interest for the individual of interest to remove a performance bias introduced by the factors.

16. A computer-readable storage medium storing computer executable instructions which when executed by a processor of a computer cause the processor to:
obtain information about performances of individuals, including performances of an individual of interest, from a digital information repository;
obtain instructions for a performance benchmarking engine trained to learn factors of the performances that impact key performance indicators independent of the individuals' performance; and
execute the instructions to determine a key performance indicator of interest for the individual of interest based at least in part on the information in the digital information repository about the performances of the individual of interest and the learned factors that impact the key performance indicator of interest.

17. The computer-readable storage medium of claim 16, wherein the computer executable instructions further cause the processor to:
extract a clinical context from the digital data repository based on a clinical context extraction algorithm and a workflow context from the digital data repository based on a clinical context extraction algorithm.

18. The computer-readable storage medium of claim 17, wherein the computer executable instructions further cause the processor to:
determine the factors from the clinical context and the workflow.

19. The computer-readable storage medium of claim 18, wherein the computer executable instructions further cause the processor to:
determine the key performance indicator of interest for the individual of interest to remove performance bias introduced by the factors.

20. The computer-readable storage medium of claim 18, wherein the computer executable instructions further cause the processor to:
determine the key performance indicator of interest for the individual of interest by excluding factors that introduce the performance bias.
